(19) United States
(12) Patent Application Publication
(10) Pub. No.: US 2020/0282488 A1
(43) Pub. Date: Sep. 10, 2020

(54) BONDING TOOL AND METHOD FOR PRODUCING A BONDING TOOL

(71) Applicant: HESSE GmbH, Paderborn (DE)

(72) Inventors: Hans-Juergen HESSE, Paderborn (DE); Michael BROEKELMANN, Delbrueck (DE); Matthias HUNSTIG, Paderborn (DE)

(73) Assignee: HESSE GmbH, Paderborn (DE)

(21) Appl. No.: 16/879,428

(22) Filed: May 20, 2020

Related U.S. Application Data
(63) Continuation of application No. PCT/DE2018/100894, filed on Nov. 5, 2018.

(30) Foreign Application Priority Data
Nov. 20, 2017 (DE) 10 2017 127 251.8

(51) Int. Cl. B23K 20/10; B23K 20/00

(52) U.S. Cl. CPC B23K 20/106; B23K 20/004

(57) ABSTRACT

A production method for a bonding tool with a body that has an elongated tool shank of the bonding tool and a tool tip adjoining the tool shank, and with a blind hole that is provided in the region of an elongated tool shank of the bonding tool and that is carried into the region of a tool tip, wherein a contact surface of the bonding tool is provided on the tool tip, comprising the following production steps: first a through opening is produced that is carried through the tool shank to the tool tip; then the through opening is closed in the region of the tool tip by a terminating element inserted into the body.

This nonprovisional application is a continuation of International Application No. PCT/DE2018/100894, which was filed on Nov. 5, 2018, and which claims priority to German Patent Application No. 10 2017 127 251.8, which was filed in Germany on Nov. 20, 2017, and which are both herein incorporated by reference.

### BACKGROUND OF THE INVENTION

### Field of the Invention

The present invention relates to a bonding tool, in particular a bonding tool for an ultrasonic laser bonding device, comprising a body extending in a longitudinal direction of the bonding tool having a tool shank and a tool tip that adjoins the tool shank, wherein a contact surface is provided on the tool tip on an end face facing away from the tool shank, and wherein a longitudinal opening designed in the manner of a blind hole is provided on the bonding tool, which opening is longitudinally extended in the region of the tool shank and which is carried into the region of the tool tip. In addition, the invention relates to a production method for a bonding tool.

### Description of the Background Art

In the prior art, various attempts are known for optimizing bonding processes through laser assistance. The goal in this context is usually to provide thermal energy by means of a laser in order to heat at least one of two electrically conductive contact partners or the bonding tool itself, and thus to facilitate the integral joining of the contact partners.

Thus, it is known from U.S. Pat. No. 5,814,784 A to heat a bonding tool by means of a laser. The bonding tool, which has an elongated tool shank as well as a tool tip designed for contact with a workpiece, is heated laterally in the region of the tool shank, which is to say from outside, for this purpose, and in the heated state is pressed against the workpiece.

From DE 102 05 609 A1, which corresponds to US 2005/0150932, a bonding apparatus is known that provides a bonding tool with a partially integrated wire feed for a bond wire (first contact partner) and, separately therefrom, a waveguide for guiding a laser beam. The waveguide is arranged externally to the bonding tool such that the second contact partner that is to be joined to the bond wire is heated by means of the laser beam before the application of the bonding tool.

From EP 0 947 281 B1, a bonding apparatus is known with a bonding tool that has a through hole oriented obliquely to a longitudinal direction of the bonding tool in the region of a tool tip. A laser beam is directed through the through hole directly onto a contact zone in which the electrically conductive contact partners, namely a bond wire guided in the bonding tool and a bond pad as the second contact partner, are integrally joined. The laser beam in this design is aimed directly onto the bond wire, and heats the same.

Similar concepts are known from U.S. Pat. No. 6,717,100 B2 and WO 2006/105393 A1, for example. In each of these cases here, a tool tip of the bonding tool is designed in the shape of a nose, and a through opening for the laser beam is provided in the region of the nose.

From U.S. Pat. No. 4,534,811 A, a bonding tool is known with a through opening that extends in a longitudinal direction of the bonding tool and tapers in the region of a tool tip of the bonding tool. Guided in the opening is a laser beam that strikes an internal lateral surface of the opening only in the region of the tool tip and heats the tool tip.

Finally, a multipart bonding tool is known from EP 0 367 705 A2 with a longitudinal opening in the manner of a blind hole that extends in a longitudinal direction of the bonding tool through a tool shank into the region of a tool tip. In the region of the tool tip, the longitudinal opening is closed in a conical shape. The conical closure geometry for the longitudinal opening in this design is provided in a terminating element of the bonding tool, which terminating element is placed on an end face of an elongated main body of the bonding tool. The bonding tool in this regard is multipart in design, or more specifically, the tool tip of the bonding tool is produced separately from the tool shank. The main body of the bonding tool has a through opening that extends in the longitudinal direction of the bonding tool and has a constant diameter. An absorption layer for the laser beam is provided on the inside of the blind hole in the region of the tool tip.

None of the above concepts has ultimately gained acceptance in practice. In particular, the structural effort and the integration of the laser technology on the device side appear to be relatively complex and expensive.

### SUMMARY OF THE INVENTION

It is therefore an object of the present invention to provide a bonding tool that is structurally simple in design and is suitable for laser-assisted bonding, and also to specify a method for producing such a bonding tool.

In an exemplary embodiment, a production method is provided for a bonding tool having a blind hole that is provided in the region of an elongated tool shank of the bonding tool and that is carried into the region of a tool tip includes the following production steps: First, a through opening is produced that extends through the tool shank to the tool tip. Then the through opening is closed in the region of the tool tip by a terminating element.

The particular advantage of the invention includes that the bonding tool according to the invention can be provided economically as a result of the two-stage production of the blind hole. In this regard, first a through opening is provided, which has a cross-sectional geometry that is always constant, for example. The through opening extends in a longitudinal direction of the bonding tool in the region of the tool shank and in the region of the tool tip. In particular, the through opening has a first aperture that is located at a contact surface formed at the tool tip, and has a second aperture that is preferably located at a second end face of the bonding tool opposite the contact surface. The second end face of the bonding tool is part of the tool shank in this design.

In another production step, the through opening is closed in the region of the tool tip by inserting a terminating element that serves as closure for the through opening. The insertion of the terminating element causes the through opening to become the blind hole.

The tool tip can include the part of the bonding tool that comes into contact with at least one of the two contact partners to be joined when the bonding tool is used as intended. For example, the tool tip is the part of the bonding tool where the tool tapers with reference to its external geometry. This is the case, in particular, with ultrasonic bonding tools, which have a wedge shape in the region of the tool tip. For example, the tool tip is defined by a projecting contact foot of the bonding tool, the nose-shaped form of the bonding tool, and/or a guide provided in the bonding tool for a bond wire. If a geometric definition of the tool tip of the bonding tool is not possible or is not unambiguously possible, then a forward third of the bonding tool on which the contact surface is provided is considered a tool tip within the scope of the invention.

The essence of the invention in this regard is to produce a blind hole in a bonding tool by first producing a through opening, and then closing this through opening by a terminating element introduced into the bonding tool. Due to the provision of the blind hole, it is possible to guide a laser beam in the bonding tool to the tool tip, and thus to heat the tool tip. Due to the heating of the tool tip, thermal energy is applied to the joint zone when the bonding tool is pressed against the at least one contact partner. The contact partners heat up, and the integral joining of the contact partners is facilitated. Direct, immediate heating of at least one contact partner by the laser beam is avoided in this case. The risk of damage to the contact partners can be counteracted in this regard. Moreover, a less exact association of a laser source providing the laser beam with the bonding tool and the contact partners is necessary. Furthermore, the situation is avoided in which the laser beam exits at the tip of the bonding tool and is scattered or reflected in an undirected manner upon contact with the contact partners. Thus the risk of injury to persons by the scattered light, for example burns, is also counteracted.

Provision is made that the body of the bonding tool is produced as a single piece. The tool shank and the tool tip are part of the body in this case. Production is carried out by forming or metal cutting, for example. The one-piece production process advantageously results in high strength for the bonding tool, and assembly of the body is avoided. Moreover, defects that result from faulty joining of the tool shank and the tool tip are avoided. This is advantageous, especially when the bonding tool is excited into bending vibrations and transverse forces are transmitted through the bonding tool—as in ultrasonic wire bonding, for example—with the result that shear loading arises in a joint.

The terminating element can be inserted into the through opening. In this regard, the terminating element closes the through opening such that a blind hole bottom of the blind hole is located in the region of the tool tip after closure of the through opening. The insertion of the terminating element into the through opening advantageously results in an especially structurally simple design for the bonding tool. Moreover, the strength of the bonding tool in the region of the tool tip is not impaired at all, or to only a very small degree.

A lateral opening that intersects the through opening can be produced in the bonding tool in the region of the tool tip. The terminating element is introduced into the lateral opening to close the through opening. In advantageous manner, the provision of the lateral opening can achieve a customized, functionally optimized design of the through opening on the one hand and of the lateral opening on the other hand. In particular, the through opening can be optimized for the requirements of the bonding process, namely the guiding or directing of the laser beam. In contrast, the lateral opening can be designed in a functionally appropriate way such that the terminating element is inserted into the lateral opening in an especially simple manner.

The terminating element can be produced oversize with respect to a cross-section of the through opening or the lateral opening. The terminating element is then inserted into the through opening or the lateral opening such that a press fit is formed after the joining, with the result that the terminating element is held in the through opening or the lateral opening in a captive manner. In particular, provision can be made here that the bonding tool and/or the terminating element is thermally pretreated, which is to say heated or cooled, before insertion of the terminating element into the bonding tool. Advantageously, an equally economical assembly of the terminating element and a secure retention of the terminating element in the bonding tool can be achieved through the provision of the press fit.

A thread can be produced on at least sections of the through opening or the lateral opening. Subsequently, a setscrew is screwed into the thread as a terminating element and the through opening is closed. An especially economical solution can advantageously be provided through the use of a setscrew as the terminating element. Moreover, a defined joint and an exact positioning of the terminating element in the through opening or the lateral opening is possible, with the result that the tool tip of the bonding tool is exactly defined geometrically and can be heated in a commensurately targeted manner.

A contact geometry that has the contact surface can be produced on the bonding tool in the region of the tool tip. To produce the contact geometry, the tool tip on the one hand and the terminating element on the other hand are both shaped. For example, the contact geometry is produced on the tool tip after the terminating element is inserted into the bonding tool. Advantageously, the provision of the contact geometry results in a guidance of a contact partner by the bonding tool that is necessary for processing reasons or is advantageous. The contact surface that is provided in the region of the contact geometry is designed to be at least partially closed in this case, and is not recessed or interrupted in the region of the terminating element, for example. Wear of the bonding tool is reduced in this regard.

Further, in order to form the blind hole in the bonding tool, a through opening can be closed by a terminating element provided in the region of the tool tip.

The particular advantage of the invention includes that a bonding tool with a blind hole that extends into the region of the tool tip is provided in an especially simple manner. By means of the blind hole, a laser beam can be introduced into the bonding tool. The laser beam heats the bonding tool in the region of the tool tip, with the result that the process of integrally joining two contact partners is facilitated. In this regard, it is possible to reduce an error rate in producing the bond joint, to shorten a process duration for the bonding, and/or to bond a material pairing that could not heretofore be integrally joined with conventional bonding methods. New application possibilities for bonding are created in this regard.

For example, in the bonding tool according to the invention the through opening can be closed by introducing the terminating element directly into the through opening. The terminating element in this case is inserted through an aperture of the through opening provided in the region of the contact surface of the bonding tool. For example, a lateral opening that intersects the through opening can be provided in the region of the tool tip. The terminating element can then be inserted into the lateral opening in order to close the through opening. The lateral opening can pass through or can be in the manner of a blind hole. The location of the terminating element after insertion is always chosen such that a blind hole bottom of the blind hole is provided in the region of the tool tip or the blind hole is continued into the region of the tool tip.

A contact geometry that has the contact surface can be implemented in the region of the tool tip, wherein the terminating element provides at least a part of the contact geometry. The bonding process can advantageously be facilitated in ribbon bonding or in wire bonding, for example, through the provision of the contact geometry. Because the terminating element provides at least a part of the contact geometry, the tool tip can be heated in a very targeted manner directly in the region where the contact surface is formed, and the bonding process can be facilitated.

The terminating element can be designed to be rotationally symmetric with respect to a terminating element longitudinal axis of the same. Advantageously, the terminating element can be produced economically due to the rotationally symmetric implementation. Moreover, assembly is simplified because no preferred orientation of the terminating element needs to be taken into account during assembly.

The terminating element longitudinal axis of the terminating element can intersect a longitudinal axis of the through opening or is coaxial to the same. Advantageously, a secure closure of the through opening is achieved and/or the manufacturing effort for the bonding tool is especially low as a result of the preferred orientation of the terminating element.

A setscrew can be provided as the terminating element. The setscrew is screwed into a thread provided in a through opening or the lateral opening. Advantageously, the cost for the bonding tool is reduced through the use of a setscrew as the terminating element. For example, the setscrews can be provided economically as standard parts. Moreover, the installation of the setscrew is simple and the terminating element is securely retained in the tool tip of the bonding tool.

A locating edge for the terminating element can be provided on the through opening or the lateral opening. Advantageously, the terminating element can be placed against the locating edge during assembly. It thus achieves a precisely predetermined position. In this regard, the provision of the locating edge prevents incorrect assembly of the terminating element.

An assembly bevel can be provided on the terminating element. Advantageously, the provision of the assembly bevel simplifies insertion of the terminating element in the bonding tool. At the same time, the assembly bevel can serve as a beam trap or deflect the laser beam in the direction of the internal lateral surface. The heating of the bonding tool in the region of the tool tip is facilitated in this regard.

Also, there can be formed on the terminating element, an opening with an aperture that is associated with the longitudinal opening of the body in such a manner that the laser beam enters the opening. The opening can be designed in the manner of a beam trap, for example, and can be provided on the terminating element laterally and/or at the end face. The provision of the opening can facilitate the heating of the bonding tool in the region of the tool tip in this regard.

Further scope of applicability of the present invention will become apparent from the detailed description given hereinafter. However, it should be understood that the detailed description and specific examples, while indicating preferred embodiments of the invention, are given by way of illustration only, since various changes combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a first production step for a bonding tool according to the invention in a sectional representation,

FIG. 2 shows the fully produced bonding tool from FIG. 1 in a sectional representation,

FIG. 3 shows a bonding tool according to the invention in a sectional representation,

FIG. 4 shows a sectional representation of a body of the bonding tool according to the invention,

FIG. 5 shows the fully produced bonding tool from FIG. 4 with a terminating element inserted into the body,

FIG. 6 shows a bonding tool according to the invention in a sectional representation,

FIG. 7 shows a bonding tool according to the invention in a sectional representation,

FIG. 8 shows a bonding tool according to the invention in a sectional representation, and

FIG. 9 shows a bonding tool according to the invention with a lateral opening provided in the region of a tool tip and with the terminating element inserted into the lateral opening, in a sectional representation.

### DETAILED DESCRIPTION

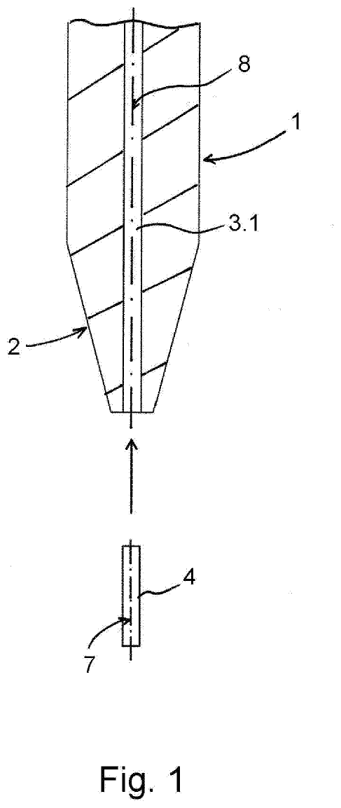

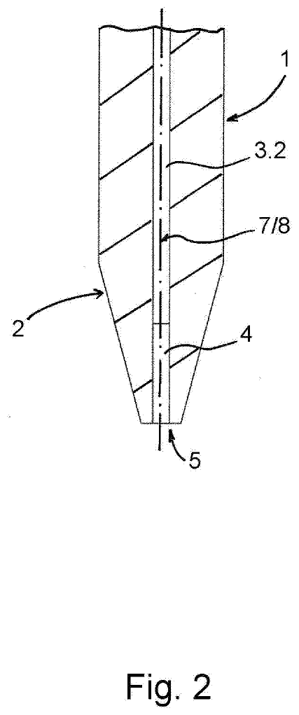

A bonding tool according to FIGS. 1 and 2 includes a body produced as a single piece having an elongated tool shank 1 and a tool tip 2 that adjoins the tool shank 1 at its end, as well as a terminating element 4. Provided on the body is a longitudinal opening implemented as a blind hole 3.2 that extends through the tool shank 1 to the region of the tool tip 2. The blind hole 3.2 is produced by the means that a through hole 3.1 is initially produced, which is then closed by the terminating element 4. To this end, the terminating element 4 is inserted into the through opening 3.1 in the region of the tool tip 2. By way of example, in this case the terminating element 4 is designed to be rotationally symmetric with respect to a terminating element longitudinal axis 7 of the same, and the terminating element longitudinal axis 7 of the terminating element 4 in the installed state is oriented coaxially to a longitudinal axis 8 of the through opening 3.1 or of the blind hole 3.2, respectively.

The tool tip 2 of the bonding tool is geometrically determined by a wedge-shaped tapering outer geometry of the bonding tool. The wedge-shaped geometry of the bonding tool is frequently used for ultrasonic bonding tools, for example.

To join the terminating element 4 to the body of the bonding tool, the terminating element 4 can be cooled to a low temperature and then inserted into the through opening 3.1 to form the blind hole 3.2, for example. In this regard, a press fit or force fit is formed after the joining, which is to say after the insertion of the terminating element 4 and the equalization of the temperatures of the terminating element 4 and the body of the bonding tool. The terminating element 4 is frictionally retained in the region of the tool tip 2 in this regard.

A contact surface 5 of the bonding tool is provided on an end face in the region of the tool tip 2. The terminating element 4 closes the through opening 3.1 in the region of the contact surface 5. An end face of the terminating element 4 forms a part of the contact surface 5 of the bonding tool in this regard.

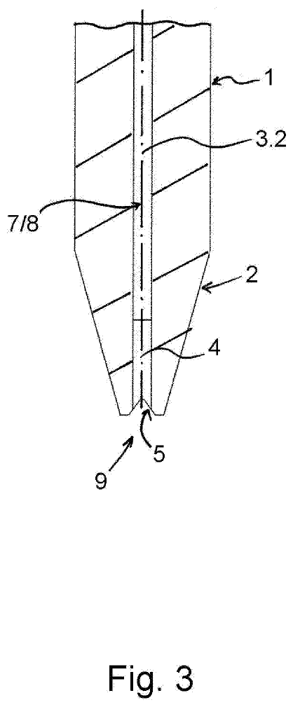

According to an alternative embodiment of the invention from FIG. 3, a contact geometry 9 that has the contact surface 5 is provided on the bonding tool on an end face provided in the region of the tool tip 2. The contact geometry 9 is wedge-shaped in design. It serves to guide a bond wire that is to be integrally joined with an electrically conductive contact partner in the region of the tool tip 2 during the bonding process or to guarantee an exact position of the bond wire during the bonding. The contact geometry 9 is implemented such that a part thereof is formed by the body, and another part thereof is formed by the terminating element 4. The contact surface 5 is formed partly on the body and partly on the terminating element 4 of the bonding tool in this regard.

The terminating element 4 according to the second embodiment of the invention can, as stated above, be inserted into the through opening 3.1 flush with an end face of the body. The terminating geometry can then be produced on the bonding tool after insertion of the terminating element 4. For example, the terminating element 4 can be inserted into the through opening 3.1 such that it is recessed from the end face of the bonding tool to produce the blind hole 3.2. In this design, an installation dimension for the terminating element 4 is determined such that a continuous contact surface 5 is the result after production of the contact geometry 9.

Alternatively, a contact geometry 9 with a discontinuous or interrupted contact surface 5 can be produced by inserting the terminating element 4 into the through opening 3.1 deeply enough that the terminating element 4 is processed only locally at its end face when the contact geometry 9 is produced.

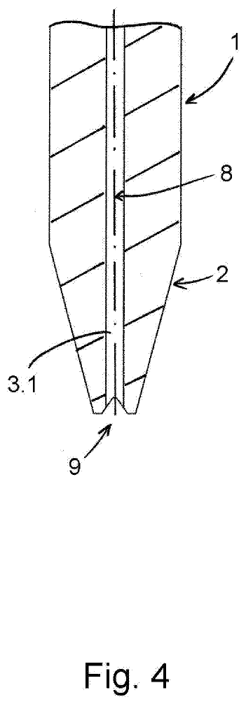

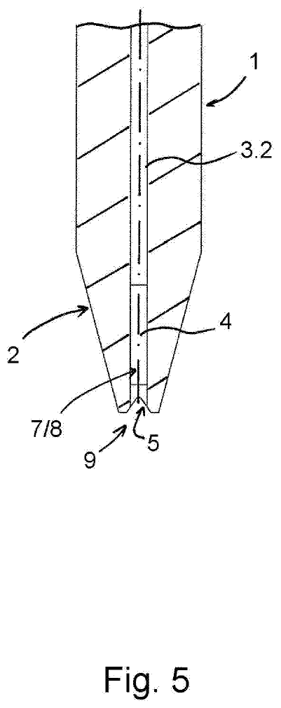

According to a third embodiment of the invention from FIG. 4 and FIG. 5, the contact geometry 9 can be produced on the body of the bonding tool that has the through opening 3.1 before the terminating element 4 is inserted into the through opening 3.1 to produce the blind hole 3.2. In this regard, the terminating element 4 is inserted into the through opening 3.1 after the contact geometry 9 is produced, and is positioned there such that an end face of the terminating element 4 that faces the tool-tip-side end face is located above the contact geometry 9 with respect to the depicted orientation of the bonding tool.

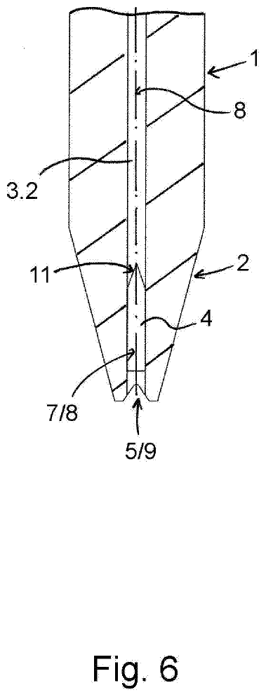

According to a fourth embodiment of the invention shown in FIG. 6, an assembly bevel 11 is provided on the terminating element 4. Due to the provision of the assembly bevel 11, the terminating element 4 can be inserted into the through opening 3.1 to produce the blind hole 3.2 of the bonding tool in an especially simple manner. In this regard, the assembly bevel 11 is provided on an end face of the terminating element 4 that faces away from the contact geometry 9 or the contact surface 5 in the assembled state of the bonding tool, and the terminating element 4 is inserted into the body of the bonding tool through an aperture of the through opening 3.1 that is provided in the region of the contact surface 5 or the contact geometry 9. At the same time, the assembly bevel 11, which forms the bottom of the blind hole or a part thereof, can deflect a laser beam that is guided in the blind hole 3.2 in the direction of an internal lateral surface of the blind hole 3.2, and thus facilitate targeted heating of the bonding tool in the region of the tool tip 2.

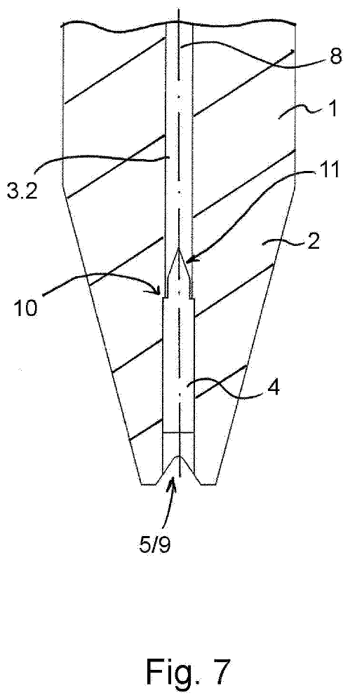

According to a fifth embodiment of the invention shown in FIG. 7, provision is made that the through opening 3.1 has a cross-sectional transition in the region of the tool tip 2, and that a locating edge 10 for the terminating element 4 is formed by the cross-sectional transition. The terminating element 4 has a maximum outer diameter that is precisely tailored to the largest inner diameter of the through opening 3.1, taking into account the joint dimensions of a press fit. Furthermore, the terminating element 4 tapers toward the assembly bevel 11. In this regard, the terminating element 4 can be inserted into the through opening 3.1 precisely to the locating edge 10. Thus, in the assembled state the terminating element 4 rests against the locating edge 10 and consequently always has an exactly defined position with respect to the body of the bonding tool.

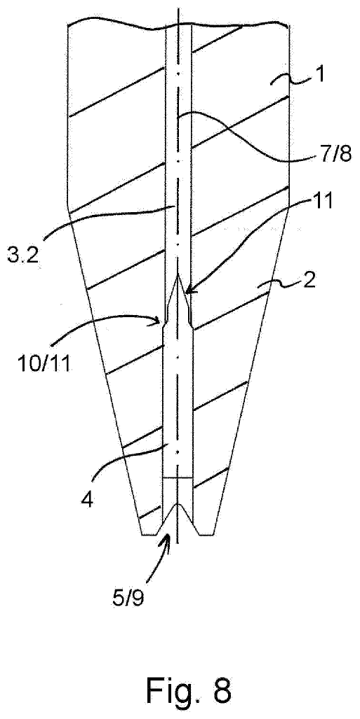

According to a sixth embodiment of the invention from FIG. 8, the locating edge 10, which is produced on the body of the bonding tool, is designed to be oblique with respect to the longitudinal axis 8 of the blind hole 3.2 or of the through opening 3.1. In a corresponding manner, a contact bevel is formed on the terminating element 4 with which the terminating element 4 is placed against the locating edge 10 formed on the body. In this regard, an exact positioning of the terminating element 4 in the through opening 3.1 is also guaranteed according to the sixth exemplary embodiment of the invention. In addition, the contact bevel serves as an assembly bevel 11 for the terminating element 4.

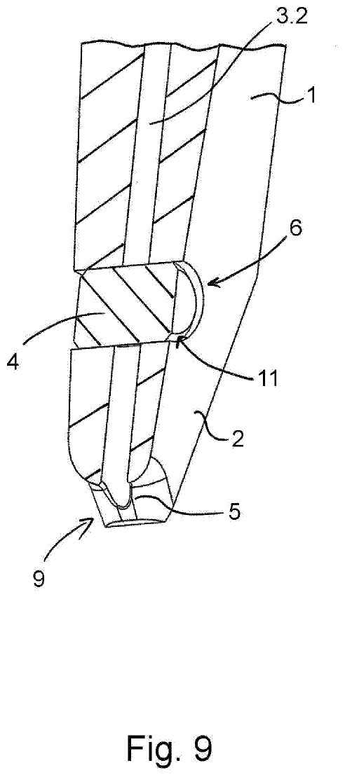

According to an alternative embodiment of the invention from FIG. 9, a lateral opening 6, which intersects the through opening 3.1 extending in the longitudinal direction of the body, is provided on the body of the bonding tool in the region of the tool tip. The terminating element 4 is then provided in the lateral opening 6. The terminating element 4 is inserted into the lateral opening 6 in such a manner, and a cross-section of the lateral opening 6 is dimensioned in such a manner—with respect to a cross-section of the through opening 3.1—that the terminating element 4 completely closes the through opening 3.1 to form the blind hole 3.2. Consequently, here—in contrast to the abovementioned exemplary embodiments of the invention—an additional opening is provided in the bonding tool, and the terminating element 4 is inserted into the additional opening to close the through opening 3.1. The terminating element 4 has an assembly bevel 11 as explained above.

As stated above, a press fit or force fit can always be formed between the body and the terminating element 4 to frictionally secure the terminating element 4. Alternatively, provision can be made that the terminating element 4 is adhesive-bonded or otherwise integrally fixed in the through opening 3.1 or the lateral opening 6, for example. Likewise, provision can be made that a thread is formed on at least portions of the region of the lateral opening 6 or of the through opening 3.1, and that a setscrew (headless screw) is screwed into the thread as the terminating element 4 to close the through opening 3.1 and to form the blind hole 3.2.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A production method for a bonding tool comprising a body that has an elongated tool shank of the bonding tool and a tool tip adjoining the tool shank, and comprising a blind hole that is provided in a region of an elongated tool shank of the bonding tool and that is carried into a region of a tool tip, wherein a contact surface of the bonding tool is provided on the tool tip, the method comprising:
producing a through opening that is carried through the tool shank to the tool tip; and
closing the through opening in the region of the tool tip by a terminating element inserted into the body.

2. The production method according to claim 1, wherein the terminating element is inserted into the through opening.

3. The production method according to claim 1, wherein a lateral opening that intersects the through opening is produced in the bonding tool, and wherein the terminating element is introduced into the lateral opening.

4. The production method according to claim 1, wherein the terminating element is produced oversize with respect to a cross-section of the through opening or the lateral opening, and then is inserted into the through opening or into the lateral opening such that a press fit is formed after the joining.

5. The production method according to claim 1, wherein a thread is produced on at least sections of the through opening and/or the lateral opening, and wherein a setscrew is screwed into the thread as a terminating element.

6. The production method according to claim 1, wherein a contact geometry that has the contact surface is produced on the bonding tool in the region of the tool tip, wherein the tool tip and the terminating element inserted into the bonding tool are shaped for this purpose.

7. The production method according to claim 6, wherein the contact geometry is produced on the tool tip after the terminating element is inserted into the bonding tool.

8. A bonding tool, in particular for an ultrasonic laser bonding device, the bonding tool comprising:
a body extending in a longitudinal direction of the bonding tool having a tool shank and a tool tip that adjoins the tool shank;
a contact surface provided on the tool tip on an end face facing away from the tool shank;
a longitudinal opening designed in the manner of a blind hole is provided on the bonding tool, the longitudinal opening longitudinally extending in a region of the tool shank and which is carried into the region of the tool tip; and
a through opening, provided to form the blind hole in the bonding tool, is closed by a terminating element provided in the region of the tool tip.

9. The bonding tool according to claim 8, wherein a contact geometry on which the contact surface is formed is implemented on the tool tip, and wherein the terminating element provides at least a part of the contact geometry.

10. The bonding tool according to claim 8, wherein the terminating element is designed to be rotationally symmetric with respect to a terminating element longitudinal axis.

11. The bonding tool according to claim 8, wherein the terminating element longitudinal axis of the terminating element intersects a longitudinal axis of the through opening and/or is orthogonal and/or coaxial to the same.

12. The bonding tool according to claim 8, wherein a setscrew is provided as the terminating element, and wherein the setscrew is screwed into a thread provided in the through opening and/or in a lateral opening that intersects the through opening.

13. The bonding tool according to claim 8, wherein a locating edge for the terminating element is provided on the through opening or on the lateral opening against which locating edge the terminating element is placed.

14. The bonding tool according to claim 8, wherein an assembly bevel is implemented on the terminating element, and/or wherein the terminating element forms a blind hole bottom of the blind hole, and/or wherein the terminating element has an opening which the laser beam enters.

15. The bonding tool according to claim 8, wherein the blind hole extends in the longitudinal direction of the bonding tool, and/or wherein the blind hole has a constant cross-section and/or a circular cross-section in the longitudinal direction.
